(19) United States
(12) Patent Application Publication
(10) Pub. No.: US 2006/0151555 A1
(43) Pub. Date: Jul. 13, 2006

(54) Pivotal cargo carrier for vehicles

(76) Inventor: Theodore M. Mills, Big Pool, MD (US)

Correspondence Address: ASHKAN NAJAFI, P.A., 6817 SOUTHPOINT PARKWAY, SUITE 2301, JACKSONVILLE, FL, 32216, US

(21) Appl. No.: 11/034,533

(22) Filed: Jan. 13, 2005

(51) Int. Cl. B60R 11/00; B60R 7/00; B60R 9/00

(52) U.S. Cl. 224/509; 224/526; 224/521; 224/42.33

(57) ABSTRACT

A cargo carrier includes an elongated tubular cross-member including an anchor flange connected thereto and disposed medially thereof. The anchor flange has a plurality of apertures and fits into a vehicle hitch receiver such that a quick-release locking pin traverses through aligned apertures. A rectangular rack section is connected to the cross-member and has an elongated bottom surface. A mechanism is included for selectively pivoting the rack section along an arcuate path extending away from the vehicle. The extended and retracted positions are further defined when the axis is positioned substantially horizontal and substantially orthogonal to the vehicle bumper respectively. The cargo carrier further includes a mechanism for supporting the rack section at a substantially stable position.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a cargo carrier and, more particularly, to a pivotal cargo carrier for vehicles for assisting a user to support a load adjacent a vehicle during transit.

2. Prior Art

Devices for expanding the cargo capacity for ordinary passenger vehicles, trucks, vans and sports utility vehicles have been known in the art for quite some time. A drawback to the devices known in the art is that they require substantial modification to the vehicle itself for proper utilization, or they require extensive, more or less permanent attachments to the vehicle in order to obtain the benefit of added carrying space.

Other possible solutions to the problem of increasing luggage capacity, such as strapping a carrier to the roof of the vehicle, towing a wheeled trailer behind the vehicle, or renting an independent trailer truck have obvious disadvantages. The principal disadvantages of attaching car top carriers to a vehicle are that they are difficult to install, difficult to load and unload, due to their awkward positioning. Furthermore, they tend to damage the vehicle by installation and removal of the carrier itself, they increase airflow restrictions thus decreasing gas mileage to the car, and they are bulky and difficult to store once removed.

For this reason, it is desirable to use a trailer attached to the rear of a vehicle, thus allowing easier access to the transported items. Such trailers are not without their own problems though. The principal disadvantage of attaching a towed trailer to the rear of a vehicle is an increased difficulty in accessing the rear compartment, such as a trunk or truck-bed, of the vehicle. The towed trailer must usually be removed and subsequently reattached, which is a time and energy consuming process.

Accordingly, a need remains for a pivotal cargo carrier for vehicles in order to overcome the above-noted shortcomings. The present invention satisfies such a need by providing a pivotal cargo carrier that is convenient to use, provides easy rear access to a vehicle, and results in increased load carrying capabilities. Instead of feeling cramped within a crowded interior, or leaving certain belongings behind, the cargo carrier can safely transport extra supplies behind the vehicle. Motorists can further eliminate carrying items in their vehicles such as chain saws, fertilizer, firewood, and other items that may cause damage to their vehicle interiors. The pivotal nature of the carrier simplifies loading and unloading of items that are stored in the rear, thus saving time and energy. Such a pivotal cargo carrier will be appreciated by people wishing to take road trips with extra luggage, as well as professionals that may use it in many other applications.

### BRIEF SUMMARY OF THE INVENTION

In view of the foregoing background, it is therefore an object of the present invention to provide a pivotal cargo carrier for vehicles. These and other objects, features, and advantages of the invention are provided by an apparatus for assisting a user to support a load adjacent to a vehicle during transit.

The apparatus includes an elongated tubular cross-member formed from rigid material and has a longitudinal axis equidistantly spaced from a rear portion of a vehicle. Such a cross-member includes an anchor flange integrally connected thereto and disposed substantially medially along the length thereof. The anchor flange has a plurality of apertures and is sized and shaped for conveniently fitting into a vehicle hitch receiver such that the cross-member becomes situated rearward of the hitch receiver when a quick-release locking pin is traversed through aligned ones of the apertures.

A substantially rectangular rack section having a centrally disposed longitudinal axis is operably connected to the cross-member. Such a rack section has an elongated bottom surface formed from durable mesh material such that a heavy load can advantageously be supported thereon.

The rack section preferably further includes a base section defining a substantially planar bottom surface including raised outer edge portions extending along a perimeter of the bottom surface and terminating at a predetermined height thereabove. The base section may be provided with an aperture formed therein. The cross-member has a locking stump protruding outwardly therefrom and is removably positionable through the aperture such that the rack section can advantageously be maintained at a fixed relationship with the cross-member during transit. Such a cross-member further has an elongated support rod secured thereto that extends orthogonally away from the cross-member for conveniently assisting to maintain the bottom surface along a substantially horizontal plane when the rack section is adapted to the retracted position.

The rack section may also include a plurality of vertical support members that have opposed end portions secured to the base section adjacent to the outer edge portions thereof and terminating thereabove respectively. A top railing is connected to the support members for advantageously assisting to maintain the load positioned within the perimeter of the bottom surface.

A mechanism is included for selectively pivoting the rack section along an arcuate path extending away from the vehicle such that the rack section can conveniently be biased between extended and retracted positions defined along a selected quadrant. Such extended and retracted positions are further defined when the axis is positioned substantially horizontal and substantially orthogonal to the vehicle bumper respectively.

The pivoting mechanism preferably includes a bifurcated housing that has rotatably attached top and bottom sections. Such top and bottom sections are operably connected to the rack section and the cross-member respectively. The housing defines a vertically oriented fulcrum axis about which the rack section is adaptable during non-transit conditions. The housing preferably further includes top and bottom lids welded thereto for effectively maintaining the rod positioned therein during operating conditions. The pivoting mechanism may further include a cylindrical rod sized and shaped for being positioned within the housing. Such a rod has integrally situated top and bottom halves welded to an interior surface of the housing top section and spaced inwardly from the housing bottom section respectively such that the top housing section is rotatable in sync with the rod while the bottom housing section is maintained at a stationary position.

The apparatus further includes a mechanism for supporting the rack section at a substantially stable position such that a user can readily position the heavy load onto the bottom surface after the rack section is pivoted to the extended position. Such a supporting mechanism preferably includes an adjustable leg including a top end pivotally attached to a distal end of the base section. The leg further includes a lower end provided with a castor wheel for effectively engaging a ground surface and guiding the rack section along the arcuate path when the load is placed thereon.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a perspective view showing a pivotal cargo carrier for vehicles in a preferred environment, in accordance with the present invention;

FIG. 2 is an enlarged perspective view of the carrier shown in FIG. 1, showing the rack section pivoted outwardly;

FIG. 3 is a cross-sectional view of the carrier shown in FIG. 2, taken along line 3-3; and

FIG. 4 is a side elevational view of the carrier shown in FIG. 1, showing the support mechanism pivoted for transit use.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

The apparatus of this invention is referred to generally in FIGS. 14 by the reference numeral 10 and is intended to provide a pivotal cargo carrier for vehicles. It should be understood that the carrier 10 may be used to carry many different types of items and should not be limited to transporting only luggage items.

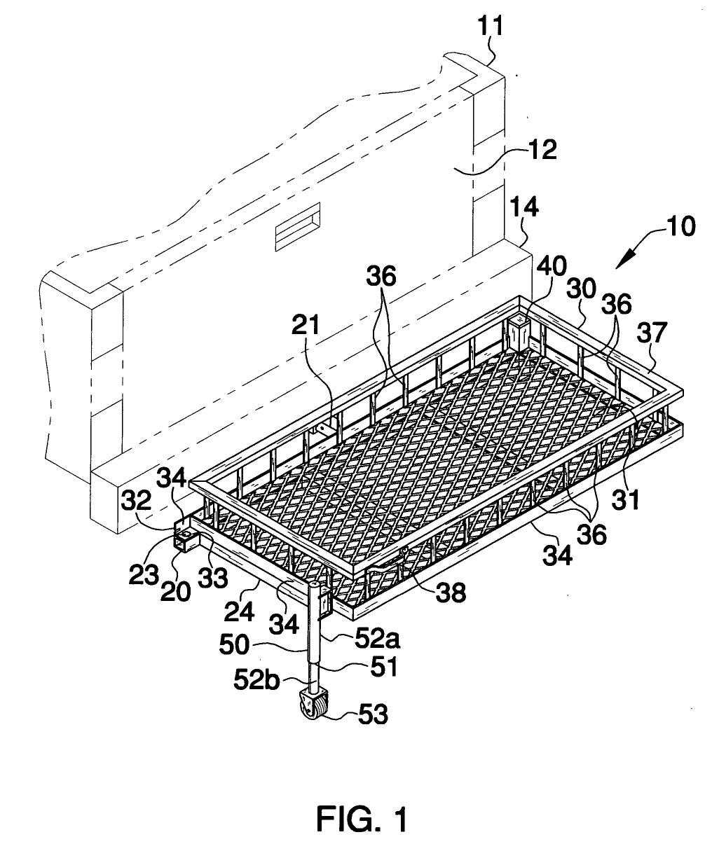

Referring initially to FIG. 1, the carrier 10 includes an elongated tubular cross-member 20 formed from rigid material and having a longitudinal axis equidistantly spaced from a rear portion 12 of a vehicle 11. Such a cross-member 20 includes an anchor flange 21 integrally connected thereto and disposed substantially medially along the length thereof. The anchor flange 21 has a plurality of apertures 22 and is sized and shaped for conveniently fitting into a vehicle hitch receiver 13 such that the cross-member 20 becomes situated rearward of the hitch receiver 13 when a quick-release locking pin (not shown) is traversed through aligned ones of the apertures 22.

Referring to FIGS. 1 through 4, a substantially rectangular rack section 30 having a centrally disposed longitudinal axis is operably connected to the cross-member 20. Such a rack section 30 has an elongated bottom surface 31 formed from durable mesh material such that a heavy load can advantageously be supported thereon while the vehicle 11 is either stationary or in motion.

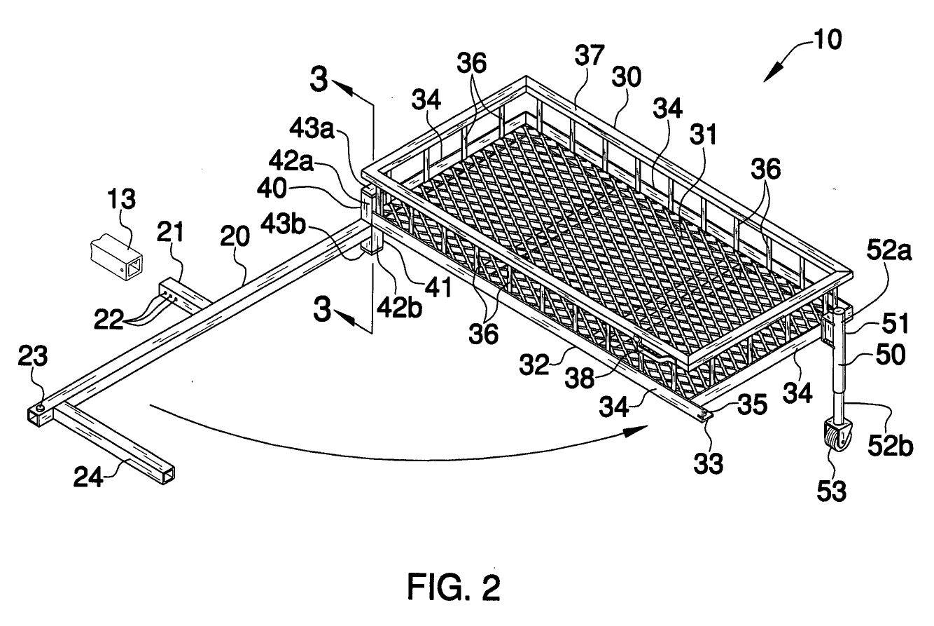

Referring to FIGS. 1 and 2, the rack section 30 further includes a base section 32 defining a substantially planar bottom surface 33 including raised outer edge portions 34 extending along a perimeter of the bottom surface 33 and terminating at a predetermined height thereabove. The base section 32 is provided with an aperture 35 formed therein. The cross-member 20 has a locking stump 23 protruding outwardly therefrom that is removably positionable through the aperture 35 such that the rack section 30 can advantageously be maintained at a fixed relationship with the cross-member 20 during transit. Such a cross-member 20 further has an elongated support rod 24 secured thereto that extends orthogonally away from the cross-member 20 for conveniently assisting to maintain the bottom surface 33 along a substantially horizontal plane when the rack section 30 is adapted to a retracted position.

Referring to FIGS. 1 through 4, the rack section 30 also includes a plurality of vertical support members 36 that have opposed end portions secured to the base section 32 adjacent to the outer edge portions 34 thereof and terminating thereabove respectively. A top railing 37 is connected to the support members 36 for advantageously assisting to maintain the load positioned within the perimeter of the bottom surface 33, such that the load advantageously does not fall off of the rack section during transit. Such a top railing 37 further includes a plurality of handles 38 attached thereto for assisting a user to pivot the rack section 30 between extended and retracted positions.

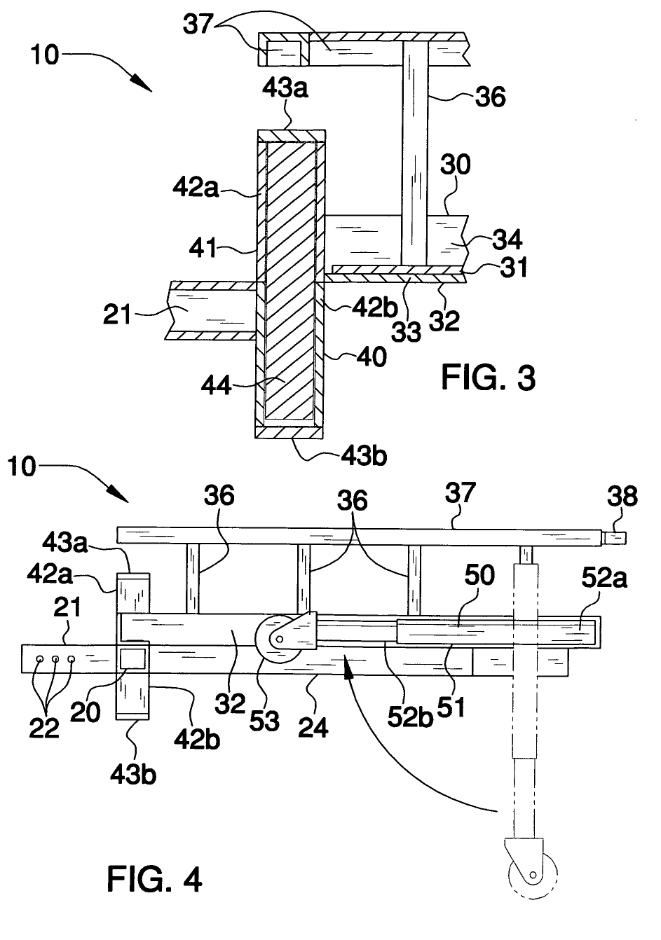

Referring to FIGS. 2 and 3, a mechanism 40 is included for selectively pivoting the rack section 30 along an arcuate path extending away from the vehicle 11 such that the rack section 30 can conveniently be biased between extended and retracted positions defined along a selected quadrant. This advantageously allows an individual to more easily gain access to the rear of the vehicle 11 without having to remove the carrier 10 in its entirety, as is often the case with similar apparatuses known in the prior art. Such extended and retracted positions are further defined when the axis is positioned substantially horizontal and substantially orthogonal to the vehicle bumper 14 respectively.

Still referring to FIGS. 2 and 3, the pivoting mechanism 40 includes a bifurcated housing 41 that has rotatably attached top 42A and bottom 42B sections. Such top 42A and bottom 42B sections are operably connected to the rack section 30 and the cross-member 20 respectively. The housing 41 defines a vertically oriented fulcrum axis about which the rack section 30 is adaptable during non-transit conditions. The housing 41 further includes top 43A and bottom 43B lids welded thereto for effectively maintaining the rod 44 (described herein below) positioned therein during operating conditions. The pivoting mechanism 40 further includes a cylindrical rod 44 sized and shaped for being positioned within the housing 41. Such a rod 44 has integrally situated top and bottom halves welded to an interior surface of the housing top section 42A and spaced inwardly from the housing bottom section 42B respectively such that the top housing section 42A is rotatable in sync with the rod 44 while the bottom housing section 42B is maintained at a stationary position. This feature advantageously allows the rack section 30 to remain attached to the vehicle 11 while still allowing a user to gain access to the rear portion 12 of the vehicle 11.

Referring to FIGS. 1, 2 and 4, the carrier 10 further includes a mechanism 50 for supporting the rack section 30 at a substantially stable position such that a user can readily position the heavy load onto the bottom surface 33 after the rack section 30 is pivoted to the extended position. Such a supporting mechanism 50 includes an adjustable leg 51 including a top end 52A pivotally attached to a distal end of the base section 32. The leg 51 further includes a lower end 52B provided with a castor wheel 53 for effectively engaging a ground surface and guiding the rack section 30 along an arcuate path when the load is placed thereon. Such a castor wheel 53 conveniently allows a user to move the rack section 30 with less effort and in a shorter period of time than would be possible in the absence thereof.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. An apparatus for assisting a user to support a load adjacent a vehicle during transit, said apparatus comprising:
an elongated cross-member formed from rigid material and having a longitudinal axis equidistantly spaced from a rear portion of a vehicle, said cross-member including an anchor flange integrally connected thereto and disposed substantially medially along the length thereof, said anchor flange being sized and shaped for fitting into a vehicle hitch receiver such that said cross-member becomes situated rearward of the hitch receiver;
a rack section having a centrally disposed longitudinal axis operably connected to said cross-member, said rack section having an elongated bottom surface formed from durable mesh material such that a heavy load can be supported thereon;
means for selectively pivoting said rack section along an arcuate path extending away from the vehicle such that said rack section can be biased between extended and retracted positions defined along a selected quadrant, said extended and retracted positions being further defined when the axis is positioned substantially horizontal and substantially orthogonal to the vehicle bumper respectively; and
means for supporting said rack section at a substantially stable position such that a user can readily position the heavy load onto said bottom surface after said rack section is pivoted to the extended position.

2. The apparatus of claim 1, wherein said rack section further comprises:
a base section defining a substantially planar bottom surface and including raised outer edge portions extending along a perimeter of said bottom surface and terminating at a predetermined height thereabove;
a plurality of vertical support members having opposed end portions secured to said base section adjacent to said outer edge portions thereof and terminating thereabove respectively; and
a top railing connected to said support members for assisting to maintain the load positioned within the perimeter of said bottom surface.

3. The apparatus of claim 2, wherein said base section is provided with an aperture formed therein, said cross-member having a locking stump protruding outwardly therefrom and being removably positionable through the aperture such that said rack section can be maintained at a fixed relationship with said cross-member during transit, said cross-member further having an elongated support rod secured thereto and extending orthogonally away from said cross-member for assisting to maintain said bottom surface along a substantially horizontal plane when said rack section is adapted to the retracted position.

4. The apparatus of claim 2, wherein said supporting means comprises:
an adjustable leg including a top end pivotally attached to a distal end of said base section, said leg further including a lower end provided with a castor wheel for engaging a ground surface and guiding said rack section along the arcuate path when the load is placed thereon.

5. The apparatus of claim 2, wherein said pivoting means comprises:
a bifurcated housing having rotatably attached top and bottom sections, said top and bottom section being operably connected to said rack section and said cross-member respectively, said housing defining a vertically oriented fulcrum axis about which said rack section is adaptable during non-transit conditions; and
a cylindrical rod sized and shaped for being positioned within said housing, said rod having integrally situated top and bottom halves welded to an interior surface of said housing top section and spaced inwardly from said housing bottom section respectively such that said top housing section is rotatable in sync with said rod while said bottom housing section is maintained at a stationary position.

6. The apparatus of claim 5, wherein said housing further comprises: top and bottom lids welded thereto for effectively maintaining said rod positioned therein during operating conditions.

7. An apparatus for assisting a user to support a load adjacent a vehicle during transit, said apparatus comprising:
an elongated tubular cross-member formed from rigid material and having a longitudinal axis equidistantly spaced from a rear portion of a vehicle, said cross-member including an anchor flange integrally connected thereto and disposed substantially medially along the length thereof, said anchor flange being sized and shaped for fitting into a vehicle hitch receiver such that said cross-member becomes situated rearward of the hitch receiver;
a substantially rectangular rack section having a centrally disposed longitudinal axis operably connected to said cross-member, said rack section having an elongated bottom surface formed from durable mesh material such that a heavy load can be supported thereon;
means for selectively pivoting said rack section along an arcuate path extending away from the vehicle such that said rack section can be biased between extended and retracted positions defined along a selected quadrant, said extended and retracted positions being further defined when the axis is positioned substantially horizontal and substantially orthogonal to the vehicle bumper respectively; and
means for supporting said rack section at a substantially stable position such that a user can readily position the heavy load onto said bottom surface after said rack section is pivoted to the extended position.

8. The apparatus of claim 7, wherein said rack section further comprises:
a base section defining a substantially planar bottom surface and including raised outer edge portions extending along a perimeter of said bottom surface and terminating at a predetermined height thereabove;
a plurality of vertical support members having opposed end portions secured to said base section adjacent to said outer edge portions thereof and terminating thereabove respectively; and
a top railing connected to said support members for assisting to maintain the load positioned within the perimeter of said bottom surface.

9. The apparatus of claim 8, wherein said base section is provided with an aperture formed therein, said cross-member having a locking stump protruding outwardly therefrom and being removably positionable through the aperture such that said rack section can be maintained at a fixed relationship with said cross-member during transit, said cross-member further having an elongated support rod secured thereto and extending orthogonally away from said cross-member for assisting to maintain said bottom surface along a substantially horizontal plane when said rack section is adapted to the retracted position.

10. The apparatus of claim 8, wherein said supporting means comprises:
an adjustable leg including a top end pivotally attached to a distal end of said base section, said leg further including a lower end provided with a castor wheel for engaging a ground surface and guiding said rack section along the arcuate path when the load is placed thereon.

11. The apparatus of claim 8, wherein said pivoting means comprises:
a bifurcated housing having rotatably attached top and bottom sections, said top and bottom section being operably connected to said rack section and said cross-member respectively, said housing defining a vertically oriented fulcrum axis about which said rack section is adaptable during non-transit conditions; and
a cylindrical rod sized and shaped for being positioned within said housing, said rod having integrally situated top and bottom halves welded to an interior surface of said housing top section and spaced inwardly from said housing bottom section respectively such that said top housing section is rotatable in sync with said rod while said bottom housing section is maintained at a stationary position.

12. The apparatus of claim 11, wherein said housing further comprises: top and bottom lids welded thereto for effectively maintaining said rod positioned therein during operating conditions.

13. An apparatus for assisting a user to support a load adjacent a vehicle during transit, said apparatus comprising:
an elongated tubular cross-member formed from rigid material and having a longitudinal axis equidistantly spaced from a rear portion of a vehicle, said cross-member including an anchor flange integrally connected thereto and disposed substantially medially along the length thereof, said anchor flange having a plurality of apertures and being sized and shaped for fitting into a vehicle hitch receiver such that said cross-member becomes situated rearward of the hitch receiver when a quick-release locking pin is traversed through aligned ones of the apertures;
a substantially rectangular rack section having a centrally disposed longitudinal axis operably connected to said cross-member, said rack section having an elongated bottom surface formed from durable mesh material such that a heavy load can be supported thereon;
means for selectively pivoting said rack section along an arcuate path extending away from the vehicle such that said rack section can be biased between extended and retracted positions defined along a selected quadrant, said extended and retracted positions being further defined when the axis is positioned substantially horizontal and substantially orthogonal to the vehicle bumper respectively; and
means for supporting said rack section at a substantially stable position such that a user can readily position the heavy load onto said bottom surface after said rack section is pivoted to the extended position.

14. The apparatus of claim 13, wherein said rack section further comprises:
a base section defining a substantially planar bottom surface and including raised outer edge portions extending along a perimeter of said bottom surface and terminating at a predetermined height thereabove;
a plurality of vertical support members having opposed end portions secured to said base section adjacent to said outer edge portions thereof and terminating thereabove respectively; and
a top railing connected to said support members for assisting to maintain the load positioned within the perimeter of said bottom surface.

15. The apparatus of claim 14, wherein said base section is provided with an aperture formed therein, said cross-member having a locking stump protruding outwardly therefrom and being removably positionable through the aperture such that said rack section can be maintained at a fixed relationship with said cross-member during transit, said cross-member further having an elongated support rod secured thereto and extending orthogonally away from said cross-member for assisting to maintain said bottom surface along a substantially horizontal plane when said rack section is adapted to the retracted position.

16. The apparatus of claim 14, wherein said supporting means comprises:
an adjustable leg including a top end pivotally attached to a distal end of said base section, said leg further including a lower end provided with a castor wheel for engaging a ground surface and guiding said rack section along the arcuate path when the load is placed thereon.

17. The apparatus of claim 14, wherein said pivoting means comprises:
a bifurcated housing having rotatably attached top and bottom sections, said top and bottom section being operably connected to said rack section and said cross-member respectively, said housing defining a vertically oriented fulcrum axis about which said rack section is adaptable during non-transit conditions; and
a cylindrical rod sized and shaped for being positioned within said housing, said rod having integrally situated top and bottom halves welded to an interior surface of said housing top section and spaced inwardly from said housing bottom section respectively such that said top housing section is rotatable in sync with said rod while said bottom housing section is maintained at a stationary position.

18. The apparatus of claim 17, wherein said housing further comprises: top and bottom lids welded thereto for effectively maintaining said rod positioned therein during operating conditions.
